(19) United States
(12) Patent Application Publication
(10) Pub. No.: US 2025/0192173 A1
(43) Pub. Date: Jun. 12, 2025

(54) POSITIVE ELECTRODE FOR SECONDARY BATTERY AND SECONDARY BATTERY

(71) Applicant: MURATA MANUFACTURING CO., LTD., Kyoto (JP)

(72) Inventor: Yuichiro HASHIZUME, Kyoto (JP)

(21) Appl. No.: 18/937,947

(22) Filed: Nov. 5, 2024

(30) Foreign Application Priority Data
Dec. 12, 2023 (JP) 2023-209322

(51) Int. Cl. H01M 4/58; H01M 4/02; H01M 4/04; H01M 4/36; H01M 4/62; H01M 10/0525

(52) U.S. Cl. CPC H01M 4/5825; H01M 4/0404; H01M 4/366; H01M 4/622; H01M 10/0525; H01M 2004/021; H01M 2004/027; H01M 2004/028

(57) ABSTRACT

A secondary battery is provided and includes a positive electrode including a positive electrode active material layer, a negative electrode, and an electrolytic solution. The positive electrode active material layer contains a plurality of positive electrode active material particles, and each of the plurality of positive electrode active material particles includes a central part containing an olivine-type phosphate compound and a covering part provided on a surface of the central part. The olivine-type phosphate compound contains manganese and iron as constituent elements, and when a sum of a content of the manganese in the olivine-type phosphate compound and a content of the iron in the olivine-type phosphate compound is 100 parts by mole, the content of the manganese in the olivine-type phosphate compound is 50 parts by mole or more and 90 parts by mole or less. The central part is a secondary particle formed by granulating a plurality of primary particles, a first median diameter relating to the plurality of primary particles is 0.01 μm or more and 0.5 μm or less, and a second median diameter relating to the plurality of secondary particles is 1 μm or more and 20 μm or less. The covering part contains a nitrile group. The positive electrode active material layer has a porosity of 20% or more and 40% or less.

### CROSS REFERENCE TO RELATED APPLICATION

The present application claims priority to Japanese patent application no. 2023-209322, filed on Dec. 12, 2023, the entire contents of which is incorporated herein by reference.

### BACKGROUND

The present technology relates to a positive electrode for a secondary battery and a secondary battery.

Since various electronic devices such as mobile phones have been widely used, secondary batteries have been developed as power sources that are small and lightweight and can achieve a high energy density. The secondary battery includes a positive electrode as a positive electrode for a secondary battery, a negative electrode, and an electrolytic solution. Various studies have been made on the configuration of the secondary battery.

Specifically, in a lithium-ion secondary battery, olivine iron as a positive electrode active material and acrylonitrile as a positive electrode binder are used, and the particle size of the positive electrode active material, the particle size and mixing amount of the positive electrode binder, and the positive electrode porosity are defined.

### SUMMARY

The present technology relates to a positive electrode for a secondary battery and a secondary battery.

Various studies on the configuration of the secondary battery have been made, but the battery characteristics of the secondary battery are still insufficient, and therefore there is room for improvement.

A positive electrode for a secondary battery and a secondary battery capable of obtaining excellent battery characteristics are desired.

A positive electrode for a secondary battery according to an embodiment of the present technology includes a positive electrode active material layer. The positive electrode active material layer contains a plurality of positive electrode active material particles, and each of the plurality of positive electrode active material particles includes a central part containing an olivine-type phosphate compound and a covering part provided on a surface of the central part. The olivine-type phosphate compound contains manganese and iron as constituent elements, and when a sum of a content of the manganese in the olivine-type phosphate compound and a content of the iron in the olivine-type phosphate compound is 100 parts by mole, the content of the manganese in the olivine-type phosphate compound is 50 parts by mole or more and 90 parts by mole or less. The central part is a secondary particle formed by granulating a plurality of primary particles, a first median diameter relating to the plurality of primary particles is 0.01 μm or more and 0.5 μm or less, and a second median diameter relating to the plurality of secondary particles is 1 μm or more and 20 μm or less. The covering part contains a nitrile group. The positive electrode active material layer has a porosity of 20% or more and 40% or less.

A secondary battery of an embodiment of the present technology includes a positive electrode, a negative electrode, and an electrolytic solution, in which the positive electrode has the same configuration as the configuration of the above-described positive electrode for a secondary battery of an embodiment of the present technology.

The positive electrode for a secondary battery or the secondary battery of an embodiment of the present technology can obtain excellent battery characteristics because each of the plurality of positive electrode active material particles includes a central part and a covering part, the central part contains an olivine-type phosphate compound, the content of manganese in the olivine-type phosphate compound is 50 parts by mole or more and 90 parts by mole or less, the first median diameter is 0.01 μm or more and 0.5 μm or less, the second median diameter is 1 μm or more and 20 μm or less, the covering part contains a nitrile group, and the positive electrode active material layer has a porosity of 20% or more and 40% or less.

The effect of the present technology is not necessarily limited to the effect described here, and may be any effect of a series of effects relating to the present technology described later.

### BRIEF DESCRIPTION OF THE FIGURES

FIG. 1 is a sectional view illustrating a configuration of a positive electrode for a secondary battery according to an embodiment of the present technology;

FIG. 2 is a sectional view illustrating a configuration of a positive electrode active material particle;

FIG. 3 is a sectional view illustrating another configuration of the positive electrode for a secondary battery;

FIG. 4 is a sectional view illustrating a configuration of a secondary battery according to an embodiment of the present technology;

FIG. 5 is a sectional view illustrating a configuration of the battery element illustrated in FIG. 4; and

FIG. 6 is a sectional view illustrating a configuration of a secondary battery for a test.

### DETAILED DESCRIPTION

The present technology will be described below in further detail including with reference to the drawings according to an embodiment.

First, a positive electrode for a secondary battery (hereinafter, simply referred to as “positive electrode”) according to an embodiment of the present technology will be described.

The positive electrode described herein is used for a secondary battery as an electrochemical device. However, the positive electrode may be used for an electrochemical device other than the secondary battery. The type of the other electrochemical device is not particularly limited, but is specifically a primary battery, a capacitor, or the like.

This positive electrode occludes and releases an electrode reactant during operation of the electrochemical device, in other words, during electrode reaction of the positive electrode. The type of the electrode reactant is not particularly limited, but is specifically a light metal such as an alkali metal or an alkaline earth metal. Specific examples of the alkali metal include lithium, sodium, and potassium. Specific examples of the alkaline earth metal include beryllium, magnesium, and calcium.

Hereinafter, a case where the electrode reactant is lithium will be described as an example. Thus, in the positive electrode, lithium is occluded and released in an ionic state during electrode reaction.

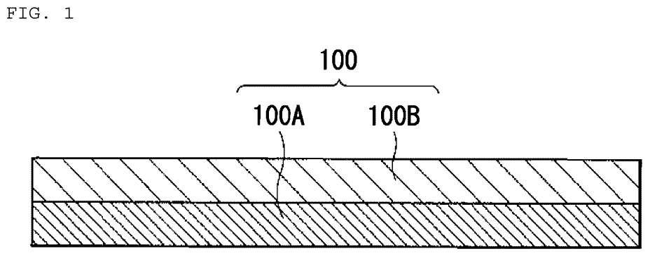

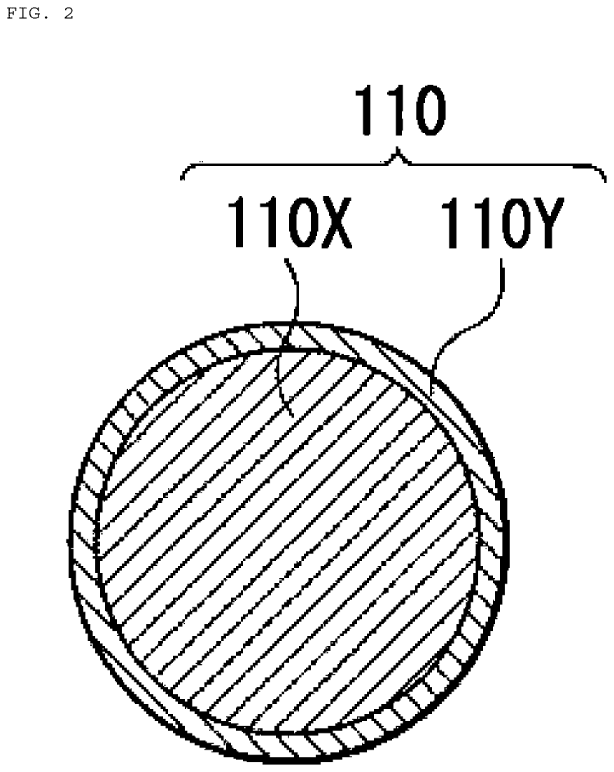

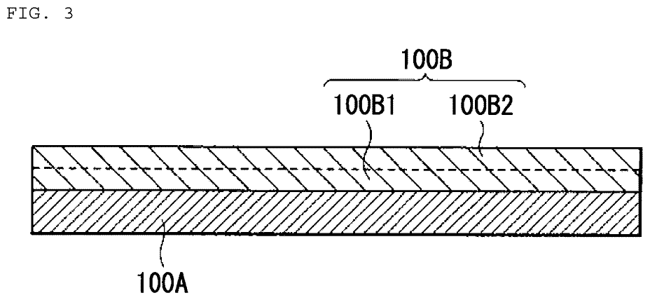

FIG. 1 illustrates a sectional configuration of a positive electrode 100 which is an example of a positive electrode according to an embodiment of the present technology. FIG. 2 illustrates a sectional configuration of a positive electrode active material particle 110. FIG. 3 illustrates another sectional configuration of the positive electrode 100.

As illustrated in FIG. 1, the positive electrode 100 includes a positive electrode active material layer 100B. Here, the positive electrode 100 further includes a positive electrode current collector 100A that supports the positive electrode active material layer 100B. The positive electrode current collector 100A may be omitted.

As illustrated in FIG. 1, the positive electrode current collector 100A is a conductive member that supports the positive electrode active material layer 100B. Here, the positive electrode current collector 100A has a pair of surfaces on which the positive electrode active material layer 100B is provided. The positive electrode current collector 100A contains a conductive material such as a metal material, and specific examples of the conductive material include aluminum.

Here, as illustrated in FIG. 1, the positive electrode active material layer 100B is provided on one surface of the positive electrode current collector 100A. The positive electrode active material layer 100B may be provided on both surfaces of the positive electrode current collector 100A.

The positive electrode active material layer 100B contains a positive electrode active material. The positive electrode active material layer 100B may further contain any one of, or two or more of other materials such as a positive electrode binder and a positive electrode conductive agent.

Specifically, as illustrated in FIG. 2, the positive electrode active material layer 100B contains a plurality of positive electrode active material particles 110 that are a plurality of particulate positive electrode active materials that occlude and release lithium. Each of the plurality of positive electrode active material particles 110 includes a central part 110X and a covering part 110Y.

In FIG. 2, only one of the plurality of positive electrode active material particles 110 is illustrated, and the sectional shape of the positive electrode active material particle 110 is illustrated in a circular shape to simplify the illustration.

The central part 110X is a part that occludes and releases lithium, and the part contains any one of, or two or more of olivine-type phosphate compounds. The olivine-type phosphate compound is a phosphate compound having an olivine-type crystal structure.

The central part 110X contains the olivine-type phosphate compound because the crystal structure of the olivine-type phosphate compound is strong and stable, and the release of oxygen from the olivine-type phosphate compound during the electrode reaction is suppressed. As a result, lithium is stably occluded and released in the central part 110X, and thus the electrode reaction stably proceeds. Thus, in the secondary battery including the positive electrode 100, a stable battery capacity is obtained, and safety is improved.

Here, as described above, since the electrode reactant is lithium, the olivine-type phosphate compound contains lithium as a constituent element together with phosphorus and oxygen. In this case, the olivine-type phosphate compound further contains manganese and iron as constituent elements.

The content of manganese in the olivine-type phosphate compound is within a predetermined range. Specifically, when the sum of the content of manganese in the olivine-type phosphate compound and the content of iron in the olivine-type phosphate compound is 100 parts by mole, the content of manganese in the olivine-type phosphate compound is 50 parts by mole to 90 parts by mole. This is because the electron conductivity of the olivine-type phosphate compound improves when the content is within this range. This configuration can achieve both improvement of the electron conductivity of the plurality of positive electrode active material particles 110 and stabilization of the operation potential and the battery capacity in the secondary battery using the positive electrode 100.

More specifically, the olivine-type phosphate compound contains any one of, or two or more of the compounds represented by Formula (1).

LiMnₓFe₁₋ₓPO₄ (1)

(x satisfies 0.5 to 0.9.)

Specific examples of the olivine-type phosphate compound include LiMn_{0.5}Fe_{0.5}PO₄, LiMn_{0.7}Fe_{0.3}PO₄, and LiMn_{0.9}Fe_{0.1}PO₄.

Whether the central part 110X contains an olivine-type phosphate compound can be checked by analyzing the central part 110X using an analysis method such as an X-ray diffraction method (XDR). Whether the olivine-type phosphate compound contains manganese and iron as constituent elements can be checked by analyzing the central part 110X using an analysis method such as inductively coupled plasma (ICP) emission spectrometry.

In particular, the central part 110X is a granulated body, and more specifically, the central part is a secondary particle obtained by granulating a plurality of primary particles. Here, since the plurality of primary particles are aggregated with each other, the secondary particle that is the central part 110X is an aggregate of the plurality of primary particles.

As described above, the positive electrode active material layer 100B contains a plurality of positive electrode active material particles 110. Thus, the positive electrode active material layer 100B includes a plurality of central parts 110X.

The central part 110X is formed into a granulated body because the conductivity of the positive electrode active material layer 100B improves.

Specifically, the olivine-type phosphate compound essentially has low electron conductivity. Thus, to improve the conductivity of the olivine-type phosphate compound, the olivine-type phosphate compound preferably has a plurality of fine particle structures. Thus, it is preferable to use secondary particles that are formed into a granulated body of a plurality of primary particles by granulating the plurality of primary particles.

With this configuration, the plurality of secondary particles are likely to come into contact with each other, resulting in improvement of the electron conductivity between the plurality of secondary particles. With this configuration, the plurality of primary particles are also likely to come into contact with each other, resulting in improvement of the electron conductivity between the primary particles. Thus, the conductivity inside the positive electrode active material particles 110 improves, and the conductivity between the plurality of positive electrode active material particles 110 also improves, resulting in improvement of the conductivity of the positive electrode active material layer 100B.

Specifically, a median diameter MD1, which is a first median diameter of the plurality of primary particles, is 0.01 μm to 0.5 μm. This is because the plurality of primary particles are likely to come into contact with each other, and thus the electron conductivity between the plurality of primary particles improves.

In particular, the median diameter MD1 is preferably 0.1 μm to 0.3 μm. This is because the plurality of primary particles are more likely to come into contact with each other, and thus the electron conductivity between the plurality of primary particles further improves.

A median diameter MD2, which is a second median diameter of the plurality of secondary particles, is 1 μm to 20 μm. This is because the plurality of secondary particles are likely to come into contact with each other, and thus the electron conductivity between the plurality of secondary particles improves.

In particular, the median diameter MD2 is 5 μm to 15 μm. This is because the plurality of secondary particles are more likely to come into contact with each other, and thus the electron conductivity between the plurality of secondary particles further improves.

The procedure for measuring the median diameter MD2 is as described below. Here, a case where the positive electrode active material layer 100B contains a plurality of positive electrode active material particles 110, a positive electrode binder, and a positive electrode conductive agent will be described.

To measure the median diameter MD2, a plurality of positive electrode active material particles 110 are analyzed using a particle size analyzer. As this particle size analyzer, a laser diffraction/scattering particle size distribution analyzer LA-960 manufactured by HORIBA, Ltd. or the like can be used.

More specifically, when the median diameter MD2 is measured, first, the positive electrode 100 is charged into a solvent, and then the solvent is stirred to peel the positive electrode active material layer 100B from the positive electrode current collector 100A. The type of the solvent is not particularly limited as long as the positive electrode binder can be dissolved. With this operation, the positive electrode binder is dissolved and removed, and thus the plurality of positive electrode active material particles 110 and the positive electrode conductive agent which are solid contents are collected.

Subsequently, the solid content is charged into a solvent, and then the solid content in the solvent is centrifuged using a centrifuge. The type of the solvent is not particularly limited as long as the plurality of positive electrode active material particles 110 and the positive electrode conductive agent can be dispersed. With this operation, the plurality of positive electrode active material particles 110 are separated from the positive electrode conductive agent, and thus the plurality of positive electrode active material particles 110 are collected.

Finally, the median diameter MD2 is measured by analyzing the plurality of positive electrode active material particles 110 using the particle size analyzer.

The procedure for measuring the median diameter MD1 is as described below.

First, a section of the positive electrode active material layer 100B is exposed by cutting the positive electrode 100 using a cutting tool such as a microtome.

Subsequently, the section of the positive electrode active material layer 100B is observed (observation magnification=10,000 times) using a scanning electron microscope (SEM). As a result, the plurality of positive electrode active material particles 110 contained in the positive electrode active material layer 100B are observed, and thus a plurality of primary particles forming each of the plurality of secondary particles which are the plurality of central parts 110X are observed.

Subsequently, any 50 primary particles whose entire outline (outer edge) can be observed are selected from the plurality of primary particles, and then the particle diameter of each of the 50 primary particles is measured. This particle diameter is the diameter of the major axis (the maximum value of the diameter in the direction of the major axis) when the primary particle includes the major axis and the minor axis. Finally, an average value of 50 particle diameters is calculated to obtain the median diameter MD1.

Since the covering part 110Y is provided on the surface of the central part 110X, it is a part protecting the surface of the central part 110X.

The covering part 110Y may be provided on the entire surface of the central part 110X or may be provided only on a part of the surface of the central part 110X. When the covering part 110Y is provided only on a part of the surface of the central part 110X, a plurality of covering parts 110Y separated from each other may be provided on the surface of the central part 110X.

In particular, the covering part 110Y contains a nitrile group. The number of nitrile groups is not particularly limited, and may be only one or two or more.

Specifically, as will be described later, in the step of forming the positive electrode active material layer 100B, a part of the positive electrode binder containing a nitrile group adheres to the surface of the central part 110X, and thus the covering part 110Y is formed by utilizing a part of the positive electrode binder. In this case, the positive electrode binder and the central part 110X are mixed with each other, which does not mean that the positive electrode binder is present near the central part 110X. On the other hand, since a part of the positive electrode binder preferentially adheres to the surface of the central part 110X because of the step of forming the positive electrode active material layer 100B, the covering part 110Y is formed by utilizing the preferential adhesion of a part of the positive electrode binder.

The details of the procedure of forming the covering part 110Y using the step of forming the positive electrode active material layer 100B will be described later.

Since the covering part 110Y is formed using the positive electrode binder as described above, the configuration of the covering part 110Y is the same as the configuration of the positive electrode binder. Specifically, since the covering part 110Y contains a nitrile group, the covering part contains any one of, or two or more of nitrile group-containing polymer compounds which are polymer compounds containing the nitrile group. The nitrile group-containing polymer compound may be a homopolymer obtained by polymerizing one type of monomer, a copolymer obtained by polymerizing two or more types of monomers, or both.

Specific examples of the homopolymer include polyacrylonitrile. Specific examples of the copolymer include an acrylonitrile-butadiene copolymer and an acrylonitrile-ethylhexyl acrylate copolymer.

The covering part 110Y is provided on the surface of the central part 110X, and the covering part 110Y contains a nitrile group, because the surface of the central part 110X having high reactivity is electrochemically protected by using the covering part 110Y. Thus, the occurrence of side reactions on the surface of the central part 110X during electrode reaction is suppressed with the central part 110X having high reactivity. In this case, particularly in the secondary battery using the positive electrode 100, the occurrence of the decomposition reaction of the electrolytic solution during charging and discharging is suppressed.

The procedure for checking whether the covering part 110Y is provided on the surface of the central part 110X is as described below.

First, the positive electrode 100 is cut by ion milling to expose a section of the positive electrode active material layer 100B.

Subsequently, the section of the positive electrode active material layer 100B is subjected to negative ion analysis using time-of-flight secondary ion mass spectrometry (TOF-SIMS) to acquire first mapping based on oxygen ions (O⁻) and second mapping based on nitrile ions (CN⁻).

The first mapping is a result of two-dimensionally displaying the detection amount of oxygen ions, and the presence range of the oxygen ions is displayed in color. This first mapping is used to specify the presence range of the central part 110X containing the olivine-type phosphate compound by specifying the presence range of the olivine-type phosphate compound containing oxygen as a constituent element.

The second mapping is a result of two-dimensionally displaying a value obtained by dividing the detection amount of nitrile ions using the detection amount of all the ions, and the presence range of the nitrile ions is displayed in color. This second mapping is used to specify the presence range of the covering part 110Y containing the nitrile group-containing polymer compound by specifying the presence range of the nitrile group-containing polymer compound containing a nitrile group.

In the second mapping, a value obtained by dividing the detection amount of nitrile ions using the detection amount of all the ions is used without using the detection amount of nitrile ions to eliminate the gradient of the detection amount of ions caused by the inclination of the sample.

In this case, a time-of-flight secondary ion mass spectrometer “TOF-SIMS 5” manufactured by IONTOF GmbH is used as the analyzer. With regard to the analysis conditions, Bi³⁺ is set as the primary ion, the acceleration voltage of the ion gun is set to 25 keV, the analysis mode is set to Burst Alignment, the current (measurement with a pulse beam) of the irradiation ions is set to 0.03 pA, the pulse frequency is set to 10 kHz, the mass range is set to 1 amu to 80 amu, and the scanning range is set to 130 μm×130 μm. Before the measurement, the measurement site is sputtered with Art ions or the like.

Subsequently, the presence range of the central part 110X is specified based on the first mapping. In the first mapping, the presence range of the central part 110X is a range defined by a substantially spherical outer edge.

Subsequently, the presence range of the covering part 110Y is specified based on the second mapping. In the second mapping, the presence range of the covering part 110Y is a range defined by a substantially ring-shaped or substantially arc-shaped outer edge.

Of course, when the covering part 110Y is not formed, the presence range of the covering part 110Y is not specified in the second mapping, and thus the presence range of the covering part 110Y is not visually recognized.

Finally, based on the first mapping and the second mapping, whether the covering part 110Y is present on the surface of the central part 110X is checked.

Specifically, the presence range of the central part 110X specified in the first mapping and the presence range of the covering part 110Y specified in the second mapping are compared with each other. Thus, when the presence range of the central part 110X and the presence range of the covering part 110Y are in contact with each other, it is determined that the covering part 110Y is provided on the surface of the central part 110X.

On the other hand, when the presence range of the central part 110X and the presence range of the covering part 110Y are not in contact with each other as a result of comparing the presence range of the central part 110X specified in the first mapping and the presence range of the covering part 110Y specified in the second mapping with each other, it is determined that the covering part 110Y is not provided on the surface of the central part 110X.

Here, the number of times of checking whether the covering part 110Y is provided on the surface of the central part 110X is not particularly limited, and may be only one time or two or more times. When the number of times is two or more, accuracy in checking whether the covering part 110Y is provided on the surface of the central part 110X improves as compared with the case where the number of times is only one.

However, as described above, since the covering part 110Y is formed because of the characteristic step of forming the positive electrode active material layer 100B to be described later, the covering part 110Y is not formed without using the characteristic step of forming the positive electrode active material layer 100B. Thus, accuracy in checking whether the covering part 110Y is provided on the surface of the central part 110X is secured when the number of times of checking whether the covering part 110Y is provided on the surface of the central part 110X is only one.

Here, as described above, in the step of forming the positive electrode active material layer 100B, a part of the positive electrode binder is preferentially adhered to the surface of the central part 110X, thereby forming the covering part 110Y. As a result, the formation amount of the covering part 110Y on the surface of the central part 110X is less likely to be non-uniformly distributed in the positive electrode active material layer 100B, and thus is likely to be uniformly distributed in the positive electrode active material layer 100B.

Specifically, since the positive electrode 100 includes the positive electrode current collector 100A, when the positive electrode active material layer 100B is supported by the positive electrode current collector 100A, the positive electrode active material layer 100B is divided based on the position of the positive electrode current collector 100A as illustrated in FIG. 3.

In this case, the positive electrode active material layer 100B is bisected in a direction in which the positive electrode current collector 100A and the positive electrode active material layer 100B face each other, that is, in a thickness direction of the positive electrode active material layer 100B (up-down direction in FIG. 3). As a result, the positive electrode active material layer 100B is divided into a lower positive electrode active material layer 100B1 which is a first positive electrode active material layer and an upper positive electrode active material layer 100B2 which is a second positive electrode active material layer. The lower positive electrode active material layer 100B1 is a part positioned closer to the positive electrode current collector 100A than the upper positive electrode active material layer 100B2, and the upper positive electrode active material layer 100B2 is an apart positioned farther from the positive electrode current collector 100A than the lower positive electrode active material layer 100B1.

Here, a total formation amount R1 of the plurality of covering parts 110Y inside the lower positive electrode active material layer 100B1 and a total formation amount R2 of the plurality of covering parts 110Y inside the upper positive electrode active material layer 100B2 are considered.

A total formation amount ratio R, which is the ratio of the total formation amount R2 to the total formation amount R1, is not particularly limited, but is preferably 0.6 to 1.4. This is because the distribution of the plurality of covering parts 110Y is substantially uniform inside the positive electrode active material layer 100B, and thus lithium is likely to be occluded and released substantially uniformly.

Specifically, when the total formation amount ratio R is smaller than 0.6 and when the total formation amount ratio R is larger than 1.4, the value of the total formation amount ratio R greatly deviates from 1.0. In this case, since the difference between the total formation amounts R1 and R2 becomes large, segregation of the covering part 110Y is likely to occur inside the positive electrode active material layer 100B. As a result, the abundance of the plurality of covering parts 110Y becomes non-uniform inside the positive electrode active material layer 100B, and thus the electrode reaction hardly proceeds uniformly.

On the other hand, when the total formation amount ratio R is 0.6 to 1.4, the value of the total formation amount ratio R becomes a value close to 1.0. In this case, since the difference between the total formation amounts R1 and R2 becomes small, segregation of the covering part 110Y is less likely to occur inside the positive electrode active material layer 100B. As a result, the abundance of the covering part 110Y becomes substantially uniform inside the positive electrode active material layer 100B, and thus the electrode reaction is likely to proceed uniformly.

The procedure for calculating the total formation amount ratio R is as described below.

First, a section of the lower positive electrode active material layer 100B1 is analyzed using TOF-SIMS to acquire mapping based on nitrile ions, and the total formation amount R1 is measured based on the mapping.

Subsequently, a section of the upper positive electrode active material layer 100B2 is analyzed using TOF-SIMS to acquire mapping based on nitrile ions, and the total formation amount R2 is measured based on the mapping.

Details of the analyzer and the analysis conditions at the time of analysis using TOF-SIMS are as described above.

Finally, the total formation amount ratio R is calculated based on a calculation formula of total formation amount ratio R (%)=(total formation amount R2/total formation amount R1)×100.

### (Porosity)

The positive electrode active material layer 100B has a plurality of voids. The plurality of voids are spaces in which no constituent elements such as the plurality of positive electrode active material particles 110 are present inside the positive electrode active material layer 100B.

A porosity P of the positive electrode active material layer 100B is 20% to 40%. This is because the flexibility of the positive electrode 100 improves, and thus damage of the positive electrode 100 is suppressed during electrode reaction. Specific examples of the damage of the positive electrode 100 include the occurrence of cracks. In the secondary battery using the positive electrode 100, since the amount of the plurality of voids in the positive electrode active material layer 100B is secured, the impregnation property of the positive electrode active material layer 100B with the electrolytic solution is secured.

In particular, the porosity P is preferably 25% to 35%. This is because the flexibility of the positive electrode 100 further improves, and thus damage of the positive electrode 100 is further suppressed during electrode reaction.

When the porosity P is measured, the positive electrode 100 is analyzed using a mercury intrusion method. In this case, a mercury porosimeter AutoPore 9500 series manufactured by Micromeritics Instrument Corporation is used as an analyzer. As the analysis conditions, the surface tension of mercury is set to 485 mN/m, the contact angle is set to 130°, and the relationship between the pore size of the plurality of voids and the pressure is approximated by 180/pressure=pore size.

The positive electrode binder is a material that binds particles such as a plurality of positive electrode active material particles to each other. As described above, the positive electrode binder is a material for forming the covering part 110Y in the step of forming the positive electrode active material layer 100B.

As described above, the positive electrode binder contains any one of, or two or more of nitrile group-containing polymer compounds. Details regarding the nitrile group-containing polymer compound are as described above.

Here, the positive electrode active material layer 100B contains a nitrile group-containing polymer compound as the positive electrode binder after the formation of the positive electrode active material layer 100B, that is, after the formation of the covering part 110Y. As a result, in the step of forming the positive electrode active material layer 100B, a part of the positive electrode binder is consumed to form the covering part 110Y, but the rest of the positive electrode binder remains in the positive electrode active material layer 100B, and thus the rest of the positive electrode binder fulfills the original binding function.

The positive electrode binder may further contain any one of, or two or more of other materials. The other materials include any one of, or two or more of materials such as synthetic rubber and a polymer compound, and the nitrile group-containing polymer compound is excluded from the polymer compound described herein. Specific examples of the synthetic rubber include styrene-butadiene rubber, fluorine rubber, and ethylene propylene diene. Specific examples of the polymer compound include polyvinylidene fluoride, polyimide, and carboxymethyl cellulose.

The positive electrode conductive agent is a material that improves the conductivity of the positive electrode active material layer 100B and contains any one of, or two or more of conductive materials such as a carbon material, a metal material, and a conductive polymer compound. Specific examples of the carbon material include graphite, carbon black, acetylene black, and Ketjen black.

In the positive electrode 100, at the time of electrode reaction, lithium is released in an ionic state from the positive electrode active material layer 100B, and lithium is occluded in an ionic state in the positive electrode active material layer 100B.

The positive electrode 100 is produced using a procedure described below as an example.

First, a plurality of primary particles containing an olivine-type phosphate compound is prepared. In this case, the median diameter MD1 is adjusted so as to be within the above range.

Subsequently, the plurality of primary particles are granulated to form a plurality of secondary particles. A plurality of central parts 110X, which are a plurality of secondary particles containing an olivine-type phosphate compound, are thus obtained. The median diameter MD2 is adjusted so as to be within the above range. The granulation is performed by, for example, spray drying. For example, a spray drying apparatus “MDP-050” manufactured by GF Corporation can be used. The method of granulation is not particularly limited.

Subsequently, a dispersant (carboxymethylcellulose) is added to a solvent (aqueous solvent) to prepare a dispersion. The type of the aqueous solvent is not particularly limited, but is specifically pure water or the like. The concentration of the dispersant is not particularly limited, but can be specifically set to 1.3% with respect to 100% of the positive electrode active material.

Subsequently, the plurality of central parts 110X are pretreated using the dispersion by charging the plurality of central parts 110X into the dispersion. In this case, the dispersion into which the plurality of central parts 110X are put may be stirred.

Since the dispersant preferentially adheres to each of the plurality of central parts 110X through this pretreatment, a base film containing the dispersant is formed on the surface of each of the plurality of central parts 110X. This base film is a film to which a part of the positive electrode binder is preferentially adhered in the subsequent process, and the thickness of the base film is extremely thin.

Subsequently, the plurality of pretreated central parts 110X, the positive electrode binder containing a nitrile group-containing polymer compound, and the positive electrode conductive agent are mixed with each other to obtain a positive electrode mixture.

Subsequently, the positive electrode mixture is charged into a solvent (aqueous solvent) to prepare a positive electrode mixture slurry.

In this case, since the base film is formed on the surface of the central part 110X, a part of the positive electrode binder preferentially adheres to the surface of the central part 110X. As a result, the nitrile-containing polymer compound is formed into a film on the surface of the central part 110X, and thus the covering part 110Y is formed on the surface of the central part 110X. The covering part 110Y contains the nitrile group derived from the nitrile group-containing polymer compound. A plurality of positive electrode active material particles 110 including the central part 110X and the covering part 110Y are thus formed.

As described above, the thickness of the base film is extremely thin, and the base film has extremely high reactivity with the nitrile group-containing polymer compound. Thus, it is difficult to directly check the presence of the base film after the formation of the covering part 110Y.

However, as described in the procedure for checking whether the covering part 110Y is provided on the surface of the central part 110X, the covering part 110Y is not formed unless the base film is used. Thus, the fact that the covering part 110Y is formed on the surface of the central part 110X means that the base film is formed on the surface of the central part 110X. Therefore, the presence of the base film can be indirectly confirmed based on the fact that the covering part 110Y is formed on the surface of the central part 110X.

Specifically, when a positive electrode binder containing a nitrile group-containing polymer compound is used in the step of forming the positive electrode active material layer 100B, a base film is not formed on the surface of each of the plurality of central parts 110X if the pretreatment of the plurality of central parts 110X using a dispersion containing a dispersant is not performed.

In such a case, there is a possibility that the nitrile group-containing polymer compound approaches the surface of the central part 110X by chance, but the nitrile group-containing polymer compound does not form a film while preferentially adhering to the surface of the central part 110X. For this reason, when whether the covering part 110Y is provided on the surface of the central part 110X is checked, the presence range of the central part 110X and the presence range of the covering part 110Y do not contact each other, and thus it is determined that the covering part 110Y is not provided on the surface of the central part 110X.

On the other hand, when a positive electrode binder containing a nitrile group-containing polymer compound is used in the step of forming the positive electrode active material layer 100B, and the pretreatment of the plurality of central parts 110X using a dispersion containing a dispersant is performed, a base film is formed on the surface of each of the plurality of central parts 110X.

In such a case, the nitrile group-containing polymer compound does not approach the surface of the central part 110X by chance, but the nitrile group-containing polymer compound forms a film while preferentially adhering to the surface of the central part 110X. For this reason, when whether the covering part 110Y is provided on the surface of the central part 110X is checked, the presence range of the central part 110X and the presence range of the covering part 110Y are in contact with each other, and thus it is determined that the covering part 110Y is provided on the surface of the central part 110X.

Subsequently, the positive electrode mixture slurry is applied to one surface of the positive electrode current collector 100A to form the positive electrode active material layer 100B.

Finally, the positive electrode active material layer 100B is compression-molded using a compression device such as a roll press machine. In this case, the positive electrode active material layer 100B may be heated or compression molding may be repeated a plurality of times. In addition, the compression conditions such as the pressing pressure and the pressing time are adjusted so that the porosity P falls within the above range.

The positive electrode active material layer 100B is thus formed on one surface of the positive electrode current collector 100A, and whereby, the positive electrode 100 is completed.

According to the positive electrode 100, each of the plurality of positive electrode active material particles 110 includes the central part 110X and the covering part 110, the central part 110X contains an olivine-type phosphate compound, the content of manganese in the olivine-type phosphate compound is 50 parts by mole to 90 parts by mole, the central part 110X is a granulated body, the median diameter MD1 is 0.01 μm to 0.5 μm, the median diameter MD2 is 1 μm to 20 μm, the covering part 110Y contains a nitrile group, and the porosity P is 20% to 40%.

In this case, as described above, a series of actions described below can be obtained.

Firstly, the central part 110X contains an olivine-type phosphate compound. In this case, release of oxygen from the central part 110X during the electrode reaction is suppressed. This allows lithium to be stably occluded and released in the positive electrode active material layer 100B, and thus an electrode reaction stably proceeds.

Secondly, the central part 110X is a granulated body, the median diameter MD1 is 0.01 μm to 0.5 μm, and the median diameter MD2 is 1 μm to 20 μm. In this case, the plurality of primary particles are likely to come into contact with each other, and thus the electron conductivity between the plurality of primary particles improves. The plurality of secondary particles are also likely to come into contact with each other, and thus the electron conductivity between the plurality of secondary particles improves. This improves the conductivity of the positive electrode active material layer 100B with an olivine-type phosphate compound having essentially low electron conductivity.

Thirdly, the covering part 110Y contains a nitrile group. This suppresses the occurrence of side reactions on the surface of the central part 110X during the electrode reaction when the central part 110X having high reactivity is used, since the surface of the central part 110X having high reactivity is electrochemically protected using the covering part 110Y.

Fourthly, the porosity P is 20% to 40%. In this case, the impregnation property of the positive electrode active material layer 100B with the electrolytic solution is secured, and the flexibility of the positive electrode 100 improves. This secures a stable electrode reaction, and suppresses damage of the positive electrode 100 during the electrode reaction.

From these, in the secondary battery including the positive electrode 100, the physical durability of the positive electrode 100 is improved while the stable progress of the electrode reaction is secured, and the operation stability of the secondary battery is improved, thus excellent battery characteristics can be obtained.

In particular, when the median diameter MD1 is 0.1 μm to 0.3 μm, the median diameter MD2 is 5 μm to 15 μm, and the porosity P is 25% to 35%, the conductivity of the positive electrode active material layer 100B further improves, and the flexibility of the positive electrode 100 further improves while the impregnation property of the positive electrode active material layer 100B with the electrolytic solution is further secured. Thus, a higher effect can be obtained.

When the positive electrode active material layer 100B is a positive electrode binder, and the positive electrode binder contains a nitrile group, the covering part 110Y is easily formed using the positive electrode binder, and thus a higher effect can be obtained. In this case, when the positive electrode binder contains polyacrylonitrile, the covering part 110Y is easily formed sufficiently, and thus a higher effect can be obtained.

In addition, when the total formation amount ratio R is 0.6 to 1.4, the distribution of the plurality of covering parts 110Y becomes substantially uniform inside the positive electrode active material layer 100B, and thus segregation of the covering parts 110Y hardly occurs. Thus, lithium is likely to be occluded and released substantially uniformly in the positive electrode active material layer 100B, and thus a higher effect can be obtained.

A secondary battery of an embodiment of the present technology to which the positive electrode 100 is applied will be described.

The secondary battery described herein is a secondary battery that can obtain a battery capacity by utilizing occlusion and release of an electrode reactant and includes a positive electrode, a negative electrode, and an electrolytic solution. Hereinafter, as described above, a case where the electrode reactant is lithium will be described as an example. A secondary battery in which the battery capacity is obtained by utilizing occlusion and release of lithium is a so-called lithium secondary battery (or lithium-ion secondary battery). In the lithium-ion secondary battery, lithium is occluded and released in an ionic state.

A charge capacity of the negative electrode is preferably larger than a discharge capacity of the positive electrode. That is, an electrochemical capacity per unit area of the negative electrode is preferably larger than an electrochemical capacity per unit area of the positive electrode. This is to prevent lithium from precipitating on the surface of the negative electrode during charging.

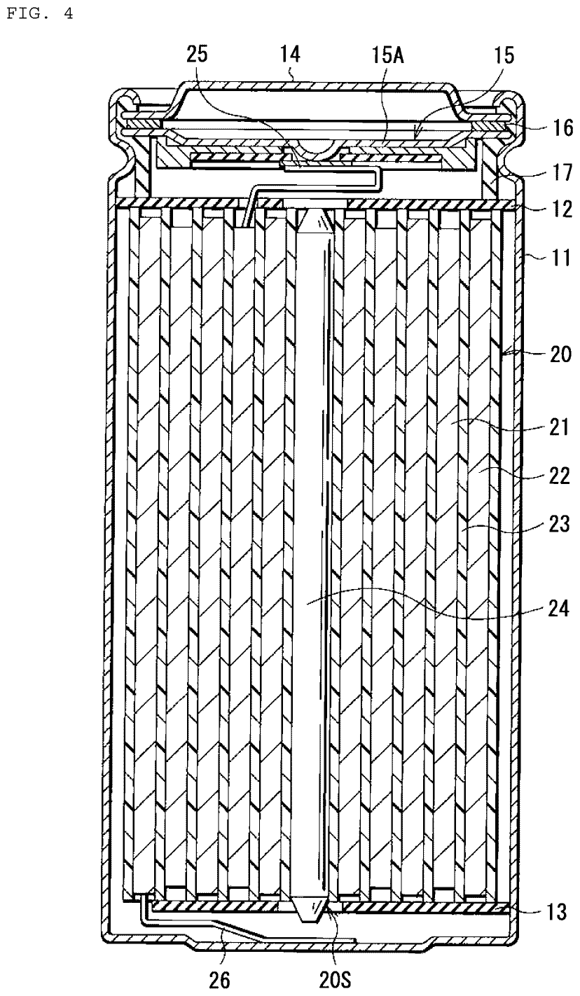

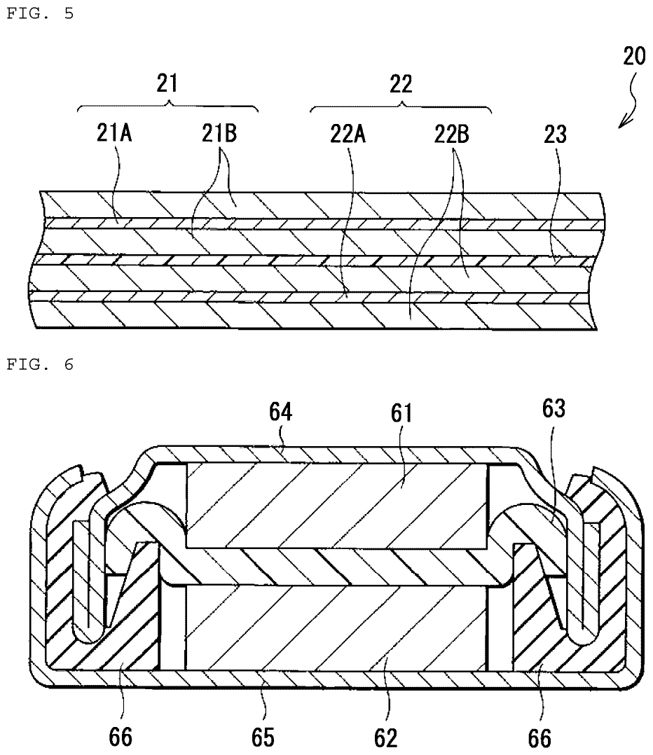

FIG. 4 illustrates a sectional configuration of a secondary battery as an example of the secondary battery according to an embodiment of the present technology. FIG. 5 illustrates a sectional configuration of a battery element 20 illustrated in FIG. 4.

As illustrated in FIGS. 4 and 5, the secondary battery includes a battery can 11, a pair of insulating plates 12 and 13, the battery element 20, a positive electrode lead 25, and a negative electrode lead 26. The secondary battery described herein is a so-called cylindrical secondary battery in which the battery element 20 is housed in the battery can 11 having a cylindrical shape.

The battery can 11 is a member that houses the battery element 20 and the like. Since the battery can 11 has one open end part and the other closed end part, the battery can 11 has a hollow structure. The battery can 11 contains any one of, or two or more of metal materials such as iron, aluminum, an iron alloy, and an aluminum alloy. A metal material such as nickel may be plated on the surface of the battery can 11.

A battery lid 14, a safety valve mechanism 15, and a PTC element 16, which is a heat sensitive resistance element, are crimped to one open end part of the battery can 11 with a gasket 17 interposed therebetween. The battery can 11 is thus sealed by the battery lid 14. Here, the battery lid 14 contains the same material as the material for forming the battery can 11. The safety valve mechanism 15 and the PTC element 16 are provided inside the battery lid 14, and the safety valve mechanism 15 is electrically connected to the battery lid 14 with the PTC element 16 interposed therebetween. The gasket 17 contains an insulating material, and asphalt or the like may be applied to the surface of the gasket 17.

In the safety valve mechanism 15, when the internal pressure of the battery can 11 reaches a certain level or more due to an internal short circuit, external heating, and the like, a disk plate 15A is reversed, and thus the electrical connection between the battery lid 14 and the battery element 20 is disconnected. To prevent abnormal heat generation due to a large current, the electrical resistance of the PTC element 16 rises as the temperature rises.

The insulating plates 12 and 13 are disposed in such a manner as to face each other with the battery element 20 interposed therebetween. Thus, the battery element 20 is sandwiched between the insulating plates 12 and 13.

The battery element 20 is a so-called power generating element, including the positive electrode 21, the negative electrode 22, a separator 23, and an electrolytic solution (not illustrated).

Here, since the battery element 20 is a so-called wound electrode body, the positive electrode 21 and the negative electrode 22 are wound while facing each other with the separator 23 interposed therebetween. A center pin 24 is inserted into a space 20S provided at the winding center of the battery element 20. The center pin 24 may be omitted.

The positive electrode 21 has the same configuration as the configuration of the positive electrode 100.

Specifically, the positive electrode 21 includes a positive electrode current collector 21A and a positive electrode active material layer 21B. The configuration of the positive electrode current collector 21A is the same as the configuration of the positive electrode current collector 100A, and the configuration of the positive electrode active material layer 21B is the same as the configuration of the positive electrode active material layer 100B. Here, the positive electrode active material layer 21B is provided on both surfaces of the positive electrode current collector 21A. However, the positive electrode active material layer 21B may be provided only on one surface of the positive electrode current collector 21A on the side where the positive electrode 21 faces the negative electrode 22.

The negative electrode 22 includes a negative electrode current collector 22A and a negative electrode active material layer 22B.

The negative electrode current collector 22A has a pair of surfaces on which the negative electrode active material layer 22B is provided. The negative electrode current collector 22A contains a conductive material such as a metal material, and specific examples of the conductive material include copper.

The negative electrode active material layer 22B contains any one of, or two or more of negative electrode active materials that occlude and release lithium. The negative electrode active material layer 22B may further contain any one of, or two or more of other materials such as a negative electrode binder and a negative electrode conductive agent. The method for forming the negative electrode active material layer 22B is not particularly limited, but is specifically any one of, or two or more of a coating method, a gas phase method, a liquid phase method, a thermal spraying method, a firing method (sintering method), and the like.

Here, the negative electrode active material layer 22B is provided on both surfaces of the negative electrode current collector 22A. However, the negative electrode active material layer 22B may be provided only on one surface of the negative electrode current collector 22A on the side where the negative electrode 22 faces the positive electrode 21.

The type of the negative electrode active material is not particularly limited, and specific examples thereof include a carbon material and a metal-based material. This is because a high energy density can be obtained.

Specific examples of the carbon material include graphitizable carbon, non-graphitizable carbon, and graphite. The graphite may be natural graphite or artificial graphite.

The metal-based material is a material including any one of, or two or more of metal elements and metalloid elements capable of forming an alloy with lithium as constituent elements, and specific examples of the metal elements and metalloid elements include silicon and tin. The metal-based material may be a simple substance, an alloy, a compound, a mixture of two or more thereof, or a material including two or more phases thereof. However, since the simple substance may contain impurities in any amount, the purity of the simple substance is not necessarily limited to 100%. Specific examples of the metal-based material include TiSi₂ and SiOₓ (0<x≤2 or 0.2<x<1.4).

The negative electrode binder contains any one of, or two or more of materials such as synthetic rubber and a polymer compound. Specific examples of the synthetic rubber include styrene-butadiene rubber, fluorine rubber, and ethylene propylene diene. Specific examples of the polymer compound include polyvinylidene fluoride, polyimide, and carboxymethyl cellulose.

The negative electrode conductive agent contains any one of, or two or more of conductive materials such as a carbon material, a metal material, and a conductive polymer compound, and specific examples of the carbon material include graphite, carbon black, acetylene black, and Ketjen black.

### (Separator)

The separator 23 is an insulating porous film interposed between the positive electrode 21 and the negative electrode 22, and it allows lithium to pass therethrough in an ionic state while preventing a short circuit resulting from contact of the positive electrode 21 and the negative electrode 22. The separator 23 contains a polymer compound such as polyethylene.

The electrolytic solution is an electrolyte in a liquid form, and each of the positive electrode 21, the negative electrode 22, and the separator 23 are impregnated with the electrolytic solution. This electrolytic solution contains a solvent and an electrolyte salt.

The solvent contains any one of, or two or more of non-aqueous solvents (organic solvents), and the electrolytic solution containing the non-aqueous solvent is a so-called non-aqueous electrolytic solution.

The non-aqueous solvent is an ester, an ether, or the like, and more specifically, it is a carbonic acid ester-based compound, a carboxylic acid ester-based compound, and a lactone-based compound, or the like. This is because a dissociative nature of the electrolyte salt and mobility of the ions improve.

The carbonic acid ester-based compound is a cyclic carbonic acid ester and a chain carbonic acid ester. Specific examples of the cyclic carbonic acid ester include ethylene carbonate and propylene carbonate, and specific examples of the chain carbonic acid ester include dimethyl carbonate, diethyl carbonate, and ethyl methyl carbonate.

The carboxylic acid ester-based compound is a chain carboxylic acid ester or the like. Specific examples of the chain carboxylic acid ester include ethyl acetate, ethyl propionate, propyl propionate, and ethyl trimethylacetate.

The lactone-based compound is a lactone or the like. Specific examples of the lactone include γ-butyrolactone and γ-valerolactone.

The ethers may be 1,2-dimethoxyethane, tetrahydrofuran, 1,3-dioxolane, 1,4-dioxane, or the like.

The non-aqueous solvent is an unsaturated cyclic carbonic acid ester, a fluorinated cyclic carbonic acid ester, a sulfonic acid ester, a phosphoric acid ester, an acid anhydride, a nitrile compound, an isocyanate compound, or the like. This is because electrochemical stability of the electrolytic solution improves.

Specific examples of the unsaturated cyclic carbonic acid ester include vinylene carbonate, vinyl ethylene carbonate, and methylene ethylene carbonate. Specific examples of the fluorinated cyclic carbonic acid ester include ethylene monofluorocarbonate and ethylene difluorocarbonate. Specific examples of the sulfonic acid ester include propane sultone and propene sultone. Specific examples of the phosphoric acid ester include trimethyl phosphate and triethyl phosphate. Specific examples of the acid anhydride include succinic anhydride, 1,2-ethanedisulfonic anhydride, and 2-sulfobenzoic anhydride. Specific examples of the nitrile compound include succinonitrile. Specific examples of the isocyanate compound include hexamethylene diisocyanate.

The electrolyte salt contains any one of, or two or more of light metal salts such as lithium salts.

Specific examples of the lithium salt include lithium hexafluorophosphate (LiPF₆), lithium tetrafluoroborate (LiBF₄), lithium trifluoromethanesulfonate (LiCF₃SO₃), lithium bis(fluorosulfonyl)imide (LiN(FSO₂)₂), lithium bis(trifluoromethanesulfonyl)imide (LiN(CF₃SO₂)₂), lithium tris(trifluoromethanesulfonyl) methide (LiC(CF₃SO₂)₃), lithium bis(oxalato) borate (LiB(C₂O₄)₂), lithium monofluorophosphate (Li₂PFO₃), and lithium difluorophosphate (LiPF₂O₂). This is because a high battery capacity can be obtained.

The content of the electrolyte salt is not particularly limited, and is specifically 0.3 mol/kg to 3.0 mol/kg with respect to the solvent. This is because high ion conductivity can be obtained.

### [Positive Electrode Lead and Negative Electrode Lead]

The positive electrode lead 25 is connected to the positive electrode current collector 21A and contains a conductive material such as aluminum. The positive electrode lead 25 is electrically connected to the battery lid 14 with the safety valve mechanism 15 interposed therebetween.

The negative electrode lead 26 is connected to the negative electrode current collector 22A and contains a conductive material such as nickel. The negative electrode lead 26 is electrically connected to the battery can 11.

The secondary battery operates as follows during charging and discharging.

During charging, in the battery element 20, lithium is released from the positive electrode 21, and the lithium is occluded in the negative electrode 22 with the electrolytic solution interposed therebetween. On the other hand, during discharging, in the battery element 20, lithium is released from the negative electrode 22, and the lithium is occluded in the positive electrode 21 with the electrolytic solution interposed therebetween. At the time of charging and the time of discharging, lithium is occluded and released in an ionic state.

When the secondary battery is produced, the positive electrode 21 and the negative electrode 22 are produced according to an exemplary procedure described below, and an electrolytic solution is prepared, then a secondary battery is assembled, and the stabilization treatment is performed on the assembled secondary battery.

The positive electrode 21 is produced by forming the positive electrode active material layers 21B on both surfaces of the positive electrode current collector 21A using the same procedure as the production procedure for the positive electrode 100 described above.

First, a mixture (negative electrode mixture) in which a negative electrode active material, a negative electrode binder, and a negative electrode conductive agent are mixed together is charged into a solvent to prepare a paste-like negative electrode mixture slurry. The solvent may be an aqueous solvent or an organic solvent. Subsequently, the negative electrode mixture slurry is applied to both sides of the negative electrode current collector 22A to form the negative electrode active material layer 22B. Finally, the negative electrode active material layer 22B may be compression-molded using a compression device such as a roll press machine. In this case, the negative electrode active material layer 22B may be heated, or compression molding may be repeated plural times. The negative electrode active material layer 22B is thus formed on both sides of the negative electrode current collector 22A, and the negative electrode 22 is produced.

An electrolyte salt is charged into the solvent. Thus, the electrolyte salt is dispersed or dissolved in the solvent, and an electrolytic solution is prepared.

First, the positive electrode lead 25 is connected to the positive electrode current collector 21A of the positive electrode 21 by a joining method such as a welding method, and the negative electrode lead 26 is connected to the negative electrode current collector 22A of the negative electrode 22 by a joining method such as a welding method.

Subsequently, the positive electrode 21 and the negative electrode 22 are laminated on each other with the separator 23 interposed therebetween, and then the positive electrode 21, the negative electrode 22, and the separator 23 are wound to prepare a wound body (not illustrated) having the space 20S. This wound body has the same configuration as the configuration of the battery element 20 except that each of the positive electrode 21, the negative electrode 22, and the separator 23 is not impregnated with the electrolytic solution. Subsequently, the center pin 24 is inserted into the space 20S of the wound body.

Subsequently, the wound body and the insulating plates 12 and 13 are housed in the battery can 11 in a state where the wound body is sandwiched between the insulating plates 12 and 13. In this case, the positive electrode lead 25 is connected to the safety valve mechanism 15 by a joining method such as a welding method, and the negative electrode lead 26 is connected to the battery can 11 by a joining method such as a welding method. Subsequently, the wound body is impregnated with the electrolytic solution by injecting the electrolytic solution into the battery can 11. As a result, each of the positive electrode 21, the negative electrode 22, and the separator 23 is impregnated with the electrolytic solution, and thus the battery element 20 is produced.

Finally, the battery lid 14, the safety valve mechanism 15, and the PTC element 16 are housed inside the battery can 11, and then the battery can 11 is crimped with the gasket 17 interposed therebetween.

As a result, the battery lid 14, the safety valve mechanism 15, the PTC element 16 are fixed to the battery can 11, the battery element 20 is sealed in the battery can 11, and thus the secondary battery is assembled.

### [Stabilization Treatment on Assembled Secondary Battery]

The assembled secondary battery is charged and discharged. Charge-discharge conditions such as an environmental temperature and the number of times of charging and discharging (the number of cycles) can be freely set. This causes a film to form on the surface of each of the positive electrode 21 and the negative electrode 22, and thus the state of the battery element 20 is electrochemically stabilized. The secondary battery is thus completed.

According to this secondary battery, the positive electrode 21 has the same configuration as the configuration of the positive electrode 100. Thus, for the reasons described above, the physical durability of the positive electrode 21 is improved while the stable progress of the charge-discharge reaction is secured, and the operation stability of the secondary battery is improved. Thus, excellent battery characteristics can be obtained.

In particular, when the secondary battery is a lithium secondary battery, a sufficient battery capacity can be stably obtained using occlusion and release of lithium, and thus a higher effect can be obtained.

Other actions and effects relating to the secondary battery are similar to the other actions and the effects relating to the positive electrode 100.

The configuration of the above-described secondary battery can be appropriately changed as described below according to an embodiment. A series of modification examples described below may be combined with each other.

In the step of forming the positive electrode active material layer 100B when the positive electrode binder contains a nitrile group-containing polymer compound, a part of the nitrile group-containing polymer compound is consumed to form the covering part 110Y, but the rest of the nitrile group-containing polymer compound remains in the positive electrode active material layer 100B, and thus the remaining nitrile group-containing polymer compound fulfills a binding function.

However, in the step of forming the positive electrode active material layer 100B when the positive electrode binder contains other materials together with the nitrile group-containing polymer compound, since all of the nitrile group-containing polymer compound is consumed to form the covering part 110Y, the nitrile group-containing polymer compound does not have to remain in the positive electrode active material layer 100B. The same effect can be obtained in this case as well since the covering part 110Y is formed, and other materials perform a binding function.

The separator 23 which is a porous film was used. However, although not specifically illustrated in the drawings, a laminated type separator may be used.

Specifically, the laminated type separator includes a porous film and a polymer compound layer. The porous film has a pair of surfaces, and the polymer compound layer is provided on one surface or both surfaces of the porous film. This is because the close contact property of the separator to each of the positive electrode 21 and the negative electrode 22 improves, and thus the winding deviation of each of the positive electrode 21, the negative electrode 22, and the separator 23 is suppressed. Thus, when a decomposition reaction of the electrolytic solution has occurred, the swelling of the secondary battery is suppressed. The polymer compound layer contains a polymer compound such as a polyvinylidene fluoride. This is because polyvinylidene fluoride has excellent physical strength and is electrochemically stable.

One or both of the porous film and the polymer compound layer may contain a plurality of insulating particles. This is because the plurality of insulating particles promote heat dissipation at the time of heat generation of the secondary battery, which improves the safety (heat resistance) of the secondary battery. The plurality of insulating particles contain any one of, or two or more of insulating materials such as an inorganic material and a resin material. Specific examples of the inorganic material include aluminum oxide, aluminum nitride, boehmite, silicon oxide, titanium oxide, magnesium oxide, and zirconium oxide. Specific examples of the resin material include an acrylic resin and a styrene resin.

In the case of producing the laminated type separator, a precursor solution containing a polymer compound, and a solvent is prepared, and then the precursor solution is applied to one surface or both surfaces of the porous film. In this case, a plurality of insulating particles may be added to the precursor solution as necessary.

Also in the case of using the laminated type separator, lithium can move between the positive electrode 21 and the negative electrode 22, and thus the same effect can be obtained. In this case, in particular, as described above, the safety of the secondary battery is improved, and thus a higher effect can be obtained.

An electrolytic solution which was an electrolyte in a liquid form was used. However, although not specifically illustrated in the drawings, an electrolyte layer that is a gel-like electrolyte may be used.

In the battery element 20 using the electrolyte layer, the positive electrode 21 and the negative electrode 22 are wound while facing each other with the separator 23 and the electrolyte layer interposed therebetween. The electrolyte layer is interposed between the positive electrode 21 and the separator 23, and is interposed between the negative electrode 22 and the separator 23.

Specifically, the electrolyte layer contains an electrolytic solution and a polymer compound, and the electrolytic solution is held by the polymer compound. This is because leakage of the electrolytic solution is prevented. The configuration of the electrolytic solution is as described above. The polymer compound contains polyvinylidene fluoride or the like. In the case of forming the electrolyte layer, a precursor solution containing an electrolytic solution, a polymer compound, and a solvent is prepared, and then the precursor solution is applied to one surface or both surfaces of each of the positive electrode 21 and the negative electrode 22.

The same effect can be obtained in the case of using the electrolyte layer as well since lithium can move between the positive electrode 21 and the negative electrode 22 with the electrolyte layer interposed therebetween. In this case, in particular, as described above, leakage of the electrolytic solution is prevented, and thus a higher effect can be obtained.

### <4. Application of Secondary Battery>

The application (application example) of the secondary battery is not particularly limited. The secondary battery to be used as a power source may be a main power source or an auxiliary power source in electronic devices, electric vehicles, and the like. The main power source is a power supply that is preferentially used regardless of the presence or absence of another power source. The auxiliary power source may be a power source that is used instead of the main power source, or is a power source that is switched from the main power source.

Specific examples of the application of the secondary battery are as described below: electronic devices such as video camcorders, digital still cameras, mobile phones, notebook personal computers, headphone stereos, portable radios, and portable information terminals; storage devices such as backup power sources and memory cards; power tools such as electric drills and electric saws; battery packs mounted on electronic devices and the like; medical electronic devices such as pacemakers and hearing aids; electric vehicles such as electric automobiles (including hybrid automobiles); and electric power storage systems such as home or industrial battery systems that store electric power in preparation for emergency or the like. In these applications, one secondary battery may be used, or a plurality of secondary batteries may be used.

A single battery or an assembled battery may be used for the battery pack. The electric vehicle is a vehicle that travels using the secondary battery as a power source for driving, and it may be a hybrid automobile including other driving source in addition to the secondary battery. In the home electric power storage system, home electric products and the like can be used by using electric power accumulated in the secondary battery as an electric power storage source.

### EXAMPLES

Examples of the present technology will be described according to an embodiment.

### Examples 1 to 21 and Comparative Examples 1 to 8

As described below, a secondary battery was produced, and then battery characteristics of the secondary battery were evaluated.

### [Production of Secondary Battery]

Here, to simply evaluate the battery characteristics, a secondary battery for a test described later was prepared. Hereinafter, the configuration of the secondary battery for a test will be described, and then a procedure for producing the secondary battery for a test will be described.

### (Configuration of Secondary Battery)

FIG. 6 illustrates a sectional configuration of the secondary battery for a test, and the secondary battery for a test is a so-called coin type lithium-ion secondary battery. Hereinafter, the secondary battery for a test is also simply referred to as “secondary battery”.

As illustrated in FIG. 6, the secondary battery includes a test electrode 61, a counter electrode 62, a separator 63, an exterior cup 64, an exterior can 65, a gasket 66, and an electrolytic solution (not illustrated).

The test electrode 61 is housed in the exterior cup 64, and the counter electrode 62 is housed in the exterior can 65. The test electrode 61 and the counter electrode 62 are laminated on each other with the separator 63 interposed therebetween, and each of the test electrode 61, the counter electrode 62, and the separator 63 is impregnated with the electrolytic solution. Since the exterior cup 64 and the exterior can 65 are crimped to each other with the gasket 66 interposed therebetween, the test electrode 61, the counter electrode 62, and the separator 63 are enclosed by the exterior cup 64 and the exterior can 65.

### (Procedure for Producing Secondary Battery)

The secondary battery illustrated in FIG. 6 was produced by the procedure described later.

### (Production of Test Electrode)

When the test electrode 61 was produced, first, a plurality of primary particles containing an olivine-type phosphate compound was prepared. In this case, as the olivine-type phosphate compound, LiMn_{0.5}Fe_{0.5}PO₄ (manganese content=50 parts by mole), LiMn_{0.7}Fe_{0.3}PO₄ (manganese content=70 parts by mole), and LiMn_{0.9}Fe_{0.1}PO₄ (manganese content=90 parts by mole) were used. When the median diameter MD1 (μm) was checked after completion of the secondary battery, the results shown in Tables 1 to 3 were obtained.

Subsequently, the plurality of primary particles were granulated to form a plurality of central parts as a plurality of secondary particles. A plurality of central parts containing an olivine-type phosphate compound were thus obtained. When the median diameter MD2 (μm) was checked after completion of the secondary battery, the results shown in Tables 1 to 3 were obtained.

Subsequently, a dispersant (carboxymethyl cellulose) was charged into a solvent (pure water as an aqueous solvent), and then the solvent was stirred to prepare a dispersion (concentration=55%).

Subsequently, the plurality of central parts were charged into the dispersion, and then the dispersion was stirred, whereby the plurality of central parts were pretreated using the dispersion. Through this pretreatment, a base film containing the dispersant was formed on the surface of each of the plurality of central parts.

Subsequently, 100 parts by mass of the plurality of pretreated central parts, 3.0 parts by mass of a positive electrode binder (polyacrylonitrile (PAN)-ethylhexyl acrylate copolymer as nitrile group-containing polymer compound), and 2.0 parts by mass of a positive electrode conductive agent (carbon black) were mixed with each other to obtain a positive electrode mixture.

Subsequently, the positive electrode mixture was charged into a solvent (pure water as an aqueous solvent), and then the solvent was stirred, whereby a positive electrode mixture slurry was prepared. As a result, a part of the nitrile group-containing polymer compound as a positive binder was preferentially adhered to the surface of each of the plurality of central parts, and thus a covering part containing a nitrile group was formed. A plurality of positive electrode active material particles including the central part and the covering part were thus obtained.

Subsequently, one surface of a positive electrode current collector (aluminum foil, thickness=12 μm) was coated with the positive electrode mixture slurry with use of a coating apparatus, and thereafter, the positive electrode mixture slurry was dried to form a positive electrode active material layer. When the total formation amount ratio R (%) was checked after completion of the secondary battery, the results shown in Tables 1 to 3 were obtained. The total formation amount ratio R (%) can be adjusted by changing the blowing temperature and the blowing amount when the positive electrode mixture slurry is dried.

Subsequently, the positive electrode active material layer was compression-molded using a pressing machine. In this case, the porosity P (%) was adjusted by changing conditions such as the pressing pressure and the pressing time. When the porosity (P) was checked after completion of the secondary battery, the results shown in Tables 1 to 3 were obtained.

Finally, the positive electrode current collector on which the positive electrode active material layer was formed was punched into a disk shape (diameter=16.5 mm). The test electrode 61 was thus produced.

For comparison, the test electrode 61 was produced using the same procedure except that a plurality of primary particles were used as they were without granulation. When the median diameter MD1 (μm) was checked after completion of the secondary battery, the results shown in Table 2 were obtained.

### (Production of Counter Electrode)

A lithium metal plate was punched into a disk shape (diameter=17 mm). The counter electrode 62 was thus obtained.

### (Preparation of Electrolytic Solution)

An electrolyte salt (LiPF₆) was added to a solvent (ethylene carbonate as a cyclic carbonate ester and diethyl carbonate as a chain carbonate ester), and then the solvent was stirred. In this case, the mixing ratio (weight ratio) of the solvent was ethylene carbonate:diethyl carbonate=30:70, and the content of the electrolyte salt in the electrolytic solution was 1 mol/kg with respect to the solvent. The electrolytic solution was thus prepared.

### (Assembly of Secondary Battery)

First, the test electrode 61 was housed in the exterior cup 64, and the counter electrode 62 was housed in the exterior can 65. Subsequently, the test electrode 61 housed in the exterior cup 64 and the counter electrode 62 housed in the exterior can 65 were laminated to each other with the separator 63 (microporous polyethylene film, thickness=20 μm, diameter=17.5 mm) impregnated with the electrolytic solution interposed therebetween. In this case, the positive electrode active material layer and the counter electrode 62 were faced to each other with the separator 63 interposed therebetween.

Subsequently, in a state where the test electrode 61 and the counter electrode 62 were laminated on each other with the separator 63 interposed therebetween, the exterior cup 64 and the exterior can 65 were crimped to each other with the gasket 66 interposed therebetween. As a result, the test electrode 61 and the counter electrode 62 were enclosed in the exterior cup 64 and the exterior can 65, and thus the secondary battery was assembled.

Finally, the assembled secondary battery was allowed to stand still (standing time=10 hours). The secondary battery was thus completed.

### [Evaluation on Battery Characteristics]

As the battery characteristics, physical durability and operation stability were evaluated, and the results shown in Tables 1 to 3 were obtained. Here, using the procedure described below, the close contact property and flexibility of the test electrode 61 were evaluated as the physical durability, and the load characteristics and the cycle characteristics of the secondary battery were evaluated as the operation stability.

### (Close Contact Property)

First, the test electrode 61 was collected by disassembling the secondary battery. Subsequently, the test electrode 61 was washed with a washing solvent (pure water), and then the test electrode 61 was dried.

Subsequently, the test electrode 61 was attached to a peeling tester in a normal temperature environment (temperature=23° C.), and then a 180° peel test was performed using the peeling tester. As a result, the positive electrode current collector was peeled off from the positive electrode active material layer, and therefore peel strength (mN/mm), which is an index for evaluating the close contact property, was measured.

Finally, the close contact property was determined based on the peel strength. Specifically, when the peel strength was 20 mN/mm or more, it was determined as “A”. When the peel strength was 10 mN/m or more and less than 20 mN/m, it was determined as “B”. When the peel strength was less than 10 mN/m, it was determined as “C”.

### (Flexibility)

First, the test electrode 61 was collected from the secondary battery, and then the test electrode 61 was washed using the same procedure as in the case of evaluating the close contact property.

Subsequently, the test electrode 61 was caused to curve by winding the test electrode 61 around a surface of an iron metal rod (diameter=4 mm) in a normal temperature environment, and then the curved test electrode 61 was left (leaving time=10 minutes). Subsequently, the state of the positive electrode active material layer, which is an index for evaluating flexibility, was observed by visually checking the state of the test electrode 61.

Finally, the flexibility was determined based on the state of the positive electrode active material layer. Specifically, when no abnormality occurred in the positive electrode active material layer, it was determined as “A”. When the positive electrode active material layer was not ruptured but fine cracks occurred in the positive electrode active material layer, it was determined as “B”. When a serious abnormality occurred in the positive electrode active material layer, it was determined as “C”. The abnormality of the positive electrode active material layer described here is cracking, damage, falling off, and the like.

### (Load Characteristics)

First, the secondary battery was charged and discharged 1 cycle in a normal temperature environment, whereby the discharge capacity (discharge capacity at the first cycle) was measured.

At the time of charging, constant current charging was performed at a current of 0.2 C until the voltage reached 3.8 V, and then constant voltage charging was performed at a voltage of 3.8 V until the current reached 0.05 C. At the time of discharging, constant current discharging was performed at a current of 0.2 C until the voltage reached 2.0 V. 0.2 C refers to a current value at which the battery capacity (theoretical capacity) can be discharged in 5 hours, and 0.05 C refers to a current value at which the battery capacity can be discharged in 20 hours.

Subsequently, the secondary battery was charged and discharged 1 cycle again in the same environment to measure the discharge capacity (discharge capacity at the second cycle).

The charge-discharge conditions were the same as those for the first cycle except that the current at the time of discharging was changed from 0.2 C to 2 C. 2 C refers to a current value at which the battery capacity can be discharged in 0.5 hours.

Subsequently, a load maintenance rate, which is an index for evaluating load characteristics, was calculated based on a calculation formula of load maintenance rate (%)=(discharge capacity at second cycle/discharge capacity at first cycle)×100.

Finally, the load characteristics were determined based on the load maintenance rate. Specifically, when the load maintenance rate was 90% or more, it was determined as “A”. When the load maintenance rate was 80% or more and less than 90%, it was determined as “B”. When the load maintenance rate was less than 80%, it was determined as “C”.

### (Cycle Characteristics)

First, the secondary battery was charged and discharged 1 cycle in a normal temperature environment, whereby the discharge capacity (discharge capacity at the first cycle) was measured. Subsequently, the secondary battery was repeatedly charged and discharged in the same environment until the total number of cycles reached 100 cycles to measure the discharge capacity (discharge capacity at the 100th cycle). The charge-discharge conditions were the same as the charge-discharge conditions for the first cycle in the case of evaluating the load characteristics.

Subsequently, a cycle maintenance rate, which is an index for evaluating the cycle characteristics, was calculated based on a calculation formula of cycle maintenance rate (%)= (discharge capacity at the 100th cycle/discharge capacity at the first cycle)×100.

Finally, the cycle characteristics were determined based on the cycle maintenance rate. Specifically, when the cycle maintenance rate was 90% or more, it was determined as “A”. When the cycle maintenance rate was 80% or more and less than 90%, it was determined as “B”. When the cycle maintenance rate was less than 80%, it was determined as “C”.

### (Comprehensive Evaluation)

Here, the respective determination results of close contact property and flexibility were obtained, and the respective determination results of load characteristics and cycle characteristics were obtained, and then the battery characteristics were comprehensively evaluated based on the four types of determination results.

Specifically, when any of the four types of determination results was C, the comprehensive evaluation was “C”. When none of the four types of determination results was C, but any of the four types of determination results was B, the comprehensive evaluation was “B”. When all of the four types of determination results were A, the comprehensive evaluation was determined as “A”.

TABLE 1
R = 1.0%

| | | | | | Positive |
|---|---|---|---|---|---|
| | Positive electrode active material | | | | electrode active |
| | particle | | | | material layer |
| | | Covering | MD1 | MD2 | P |
| | Central part | part | (μm) | (μm) | (%) |
| Comparative | LiMn_{0.5}Fe_{0.5}PO₄ | PAN | 0.005 | 8 | 28 |
| Example 1 | | | | | |
| Example 1 | LiMn_{0.5}Fe_{0.5}PO₄ | PAN | 0.01 | 8 | 28 |
| Example 2 | LiMn_{0.5}Fe_{0.5}PO₄ | PAN | 0.1 | 8 | 28 |
| Example 3 | LiMn_{0.5}Fe_{0.5}PO₄ | PAN | 0.2 | 8 | 28 |
| Example 4 | LiMn_{0.5}Fe_{0.5}PO₄ | PAN | 0.3 | 8 | 28 |
| Example 5 | LiMn_{0.5}Fe_{0.5}PO₄ | PAN | 0.5 | 8 | 28 |
| Comparative | LiMn_{0.5}Fe_{0.5}PO₄ | PAN | 0.6 | 8 | 28 |
| Example 2 | | | | | |
| Comparative | LiMn_{0.5}Fe_{0.5}PO₄ | PAN | 0.2 | 0.8 | 28 |
| Example 3 | | | | | |
| Example 6 | LiMn_{0.5}Fe_{0.5}PO₄ | PAN | 0.2 | 1 | 28 |
| Example 7 | LiMn_{0.5}Fe_{0.5}PO₄ | PAN | 0.2 | 5 | 28 |
| Example 8 | LiMn_{0.5}Fe_{0.5}PO₄ | PAN | 0.2 | 15 | 28 |
| Example 9 | LiMn_{0.5}Fe_{0.5}PO₄ | PAN | 0.2 | 20 | 28 |
| Comparative | LiMn_{0.5}Fe_{0.5}PO₄ | PAN | 0.2 | 25 | 28 |
| Example 4 | | | | | |
| Comparative | LiMn_{0.5}Fe_{0.5}PO₄ | — | 0.2 | 8 | 28 |
| Example 5 | | | | | |

| | Close | | Load | Cycle | |
|---|---|---|---|---|---|
| | contact | | maintenance | maintenance | Comprehensive |
| | property | Flexibility | rate | rate | evaluation |
| Comparative | B | A | A | C | C |
| Example 1 | | | | | |
| Example 1 | B | A | A | B | B |
| Example 2 | A | A | A | A | A |
| Example 3 | A | A | A | A | A |
| Example 4 | A | A | A | A | A |
| Example 5 | A | A | B | A | B |
| Comparative | B | A | C | B | C |
| Example 2 | | | | | |
| Comparative | C | A | A | C | C |
| Example 3 | | | | | |
| Example 6 | B | A | A | B | B |
| Example 7 | A | A | A | A | A |
| Example 8 | A | A | A | A | A |
| Example 9 | A | A | B | A | B |
| Comparative | A | A | C | A | C |
| Example 4 | | | | | |
| Comparative | A | A | A | C | C |
| Example 5 | | | | | |

TABLE 2
R = 1.0%

| | Positive electrode active material | | | | Positive |
|---|---|---|---|---|---|
| | particle | | | | electrode active |
| | | Covering | MD1 | MD2 | material layer |
| | Central part | part | (μm) | (μm) | P (%) |
| Comparative | LiMn_{0.5}Fe_{0.5}PO₄ | PAN | 0.2 | 8 | 15 |
| Example 6 | | | | | |
| Example 10 | LiMn_{0.5}Fe_{0.5}PO₄ | PAN | 0.2 | 8 | 20 |
| Example 11 | LiMn_{0.5}Fe_{0.5}PO₄ | PAN | 0.2 | 8 | 25 |
| Example 12 | LiMn_{0.5}Fe_{0.5}PO₄ | PAN | 0.2 | 8 | 35 |
| Example 13 | LiMn_{0.5}Fe_{0.5}PO₄ | PAN | 0.2 | 8 | 40 |
| Comparative | LiMn_{0.5}Fe_{0.5}PO₄ | PAN | 0.2 | 8 | 45 |
| Example 7 | | | | | |
| Example 14 | LiMn_{0.7}Fe_{0.3}PO₄ | PAN | 0.2 | 8 | 28 |
| Example 15 | LiMn_{0.9} Fe_{0.1}PO₄ | PAN | 0.2 | 8 | 35 |
| Comparative | LiMn_{0.5}Fe_{0.5}PO₄ | PAN | 1 | — | 28 |
| Example 8 | | | | | |

| | Close | | Load | Cycle | |
|---|---|---|---|---|---|
| | contact | | maintenance | maintenance | Comprehensive |
| | property | Flexibility | rate | rate | evaluation |
| Comparative | B | C | C | A | C |
| Example 6 | | | | | |
| Example 10 | A | B | B | A | B |
| Example 11 | A | A | A | A | A |
| Example 12 | A | A | A | A | A |
| Example 13 | A | A | A | B | B |
| Comparative | A | A | A | C | C |
| Example 7 | | | | | |
| Example 14 | A | A | A | A | A |
| Example 15 | A | A | A | A | A |
| Comparative | B | B | B | C | C |
| Example 8 | | | | | |

TABLE 3
MD1 = 0.2 μm, MD2 = 8 μm, P = 28%

| | Positive electrode active | | Positive electrode active |
|---|---|---|---|
| | material particle | | material layer |
| | Central part | Covering part | R ( %) |
| Example 16 | LiMn_{0.5}Fe_{0.5}PO₄ | PAN | 0.4 |
| Example 17 | LiMn_{0.5}Fe_{0.5}PO₄ | PAN | 0.6 |
| Example 18 | LiMn_{0.5}Fe_{0.5}PO₄ | PAN | 0.8 |
| Example 3 | LiMn_{0.5}Fe_{0.5}PO₄ | PAN | 1.0 |
| Example 19 | LiMn_{0.5}Fe_{0.5}PO₄ | PAN | 1.2 |
| Example 20 | LiMn_{0.5}Fe_{0.5}PO ₄ | PAN | 1.4 |
| Example 21 | LiMn_{0.5}Fe_{0.5}PO₄ | PAN | 1.6 |

| | Close | | Load | | |
|---|---|---|---|---|---|
| | contact | | maintenance | maintenance | |
| | property | Flexibility | rate | rate | evaluation |
| Example 16 | A | B | B | B | B |
| Example 17 | A | A | A | A | A |
| Example 18 | A | A | A | A | A |
| Example 3 | A | A | A | A | A |
| Example 19 | A | A | A | A | A |
| Example 20 | A | A | A | A | A |
| Example 21 | B | A | B | B | B |

As shown in Tables 1 to 3, the comprehensive evaluation regarding the four types of evaluation results (close contact property, flexibility, load characteristics, and cycle characteristics) varied according to the configuration of the test electrode 61.

Specifically, when the appropriate conditions that each of the plurality of positive electrode active material particles contained a central part and a covering part, the central part contained an olivine-type phosphate compound, the content of manganese in the olivine-type phosphate compound was 50 parts by mole to 90 parts by mole, the central part was a granulated body, the median diameter MD1 was 0.01 μm to 0.5 μm, the median diameter MD2 was 1 μm to 20 μm, the covering part contained a nitrile group, and the porosity P was 20% to 40% were satisfied (Examples 1 to 21), all of the close contact property, flexibility, load characteristics, and cycle characteristics improved, and thus the comprehensive evaluation was B or more.

On the other hand, when the above-described appropriate conditions were not satisfied (Comparative Examples 1 to 8), any of the close contact property, the flexibility, the load characteristics, and the cycle characteristics deteriorated, and thus the comprehensive evaluation was C. In this case, in particular, when the plurality of primary particles were used as they were without granulation (Comparative Example 8), the cycle characteristics significantly deteriorated.

In addition, when the above-described appropriate conditions were satisfied (Examples 1 to 21), a series of tendencies described below were obtained.

Firstly, when the median diameter MD1 was 0.1 μm to 3 μm, each of close contact property, load characteristics, and cycle characteristics further improved.

Secondly, when the median diameter MD2 was 5 μm to 15 μm, each of close contact property, load characteristics, and cycle characteristics further improved.

Thirdly, when the porosity P was 25% to 35%, each of close contact property, load characteristics, and cycle characteristics further improved.

Fourthly, when the covering part contained polyacrylonitrile which is a nitrile group-containing polymer compound, all of the close contact property, flexibility, load characteristics, and cycle characteristics sufficiently improved.

Fifthly, when the total formation amount ratio R was 0.6 to 1.4, all of the closed contact property, flexibility, load characteristics, and cycle characteristics sufficiently improved.

From the results shown in Tables 1 and 2, when each of the plurality of positive electrode active material particles contained a central part and a covering part, the central part contained an olivine-type phosphate compound, the content of manganese in the olivine-type phosphate compound was 50 parts by mole to 90 parts by mole, the central part was a granulated body, the median diameter MD1 was 0.01 μm to 0.5 μm, the median diameter MD2 was 1 μm to 20 μm, the covering part contained a nitrile group, and the porosity P was 20% to 40%, all of the close contact property, flexibility, load characteristics, and cycle characteristics improved, and therefore excellent battery characteristics were obtained.

Although the present technology has been described herein according to an embodiment including Examples, the configurations of the present technology are not limited thereto, and are therefore modifiable in a variety of ways.

Specifically, a case where the battery structure of the secondary battery is a cylindrical type and a coin type has been described. However, the battery structure of the secondary battery is not particularly limited, and thus may be a laminate film type, a square type, a button type, and the like.

A case where the element structure of the battery element is a winding type has been described. However, the element structure of the battery element is not particularly limited, and may be a laminated type, a zigzag folded type, or the like. In the laminated type, the positive electrode and the negative electrode are laminated on each other, and in the zigzag folded type, the positive electrode and the negative electrode are folded in a zigzag manner.

A case where the electrode reactant is lithium has been described, but the electrode reactant is not particularly limited. Specifically, as described above, the electrode reactant may be other alkali metals such as sodium and potassium, or alkaline earth metals such as beryllium, magnesium, and calcium. In addition, the electrode reactant may be another light metal such as aluminum.

Since the effects described in the present specification are merely examples, the effects of the present technology are not limited to the effects described in the present specification. Therefore, other effects regarding the present technology may be obtained.

The present technology may also take the following configurations according to an embodiment.

<1>

A secondary battery including:
a positive electrode including a positive electrode active material layer;
a negative electrode; and
an electrolytic solution,
in which
the positive electrode active material layer contains a plurality of positive electrode active material particles,
each of the plurality of positive electrode active material particles includes:
a central part containing an olivine-type phosphate compound; and
a covering part provided on a surface of the central part,
the olivine-type phosphate compound contains manganese and iron as constituent elements,
when a sum of a content of the manganese in the olivine-type phosphate compound and a content of the iron in the olivine-type phosphate compound is 100 parts by mole, the content of the manganese in the olivine-type phosphate compound is 50 parts by mole or more and 90 parts by mole or less,
the central part is a secondary particle formed by granulating a plurality of primary particles,
a first median diameter relating to the plurality of primary particles is 0.01 μm or more and 0.5 μm or less,
a second median diameter relating to the plurality of secondary particles is 1 μm or more and 20 μm or less,
the covering part contains a nitrile group, and
the positive electrode active material layer has a porosity of 20% or more and 40% or less.
   <2>

The secondary battery according to <1>, in which
the first median diameter is 0.1 μm or more and 0.3 μm or less,
the second median diameter is 5 μm or more and 15 μm or less, and
the porosity is 25% or more and 35% or less.
   <3>

The secondary battery according to <1> or <2>, in which
the positive electrode active material layer further contains a positive electrode binder, and
the positive electrode binder contains a nitrile group.
   <4>

The secondary battery according to <3>, in which the positive electrode binder contains at least one of polyacrylonitrile and an acrylonitrile-ethylhexyl acrylate copolymer.

<5>

The secondary battery according to any one of <1> to <4>, in which
the positive electrode further includes a positive electrode current collector that supports the positive electrode active material layer, and
when the positive electrode active material layer is bisected into a first positive electrode active material layer positioned on a side close to the positive electrode current collector and a second positive electrode active material layer positioned on a side far from the positive electrode in a thickness direction of the positive electrode active material layer,
a ratio of a total formation amount of a plurality of the covering parts in the second positive electrode active material layer to a total formation amount of a plurality of the covering parts in the first positive electrode active material layer is 0.6 or more and 1.4 or less.
   <6>

The secondary battery according to any one of <1> to <5>, the secondary battery being a lithium secondary battery.

<7>

A positive electrode for a secondary battery, the positive electrode including a positive electrode active material layer,
in which
the positive electrode active material layer contains a plurality of positive electrode active material particles,
each of the plurality of positive electrode active material particles includes:
a central part containing an olivine-type phosphate compound; and
a covering part provided on a surface of the central part,
the olivine-type phosphate compound contains manganese and iron as constituent elements,
when a sum of a content of the manganese in the olivine-type phosphate compound and a content of the iron in the olivine-type phosphate compound is 100 parts by mole, the content of the manganese in the olivine-type phosphate compound is 50 parts by mole or more and 90 parts by mole or less,
the central part is a secondary particle formed by granulating a plurality of primary particles,
a first median diameter relating to the plurality of primary particles is 0.01 μm or more and 0.5 μm or less,
a second median diameter relating to the plurality of secondary particles is 1 μm or more and 20 μm or less,
the covering part contains a nitrile group, and
the positive electrode active material layer has a porosity of 20% or more and 40% or less.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a positive electrode including a positive electrode active material layer;
a negative electrode; and
an electrolytic solution,
wherein
the positive electrode active material layer contains a plurality of positive electrode active material particles,
each of the plurality of positive electrode active material particles includes:
a central part containing an olivine-type phosphate compound; and
a covering part provided on a surface of the central part,
the olivine-type phosphate compound contains manganese and iron as constituent elements,
when a sum of a content of the manganese in the olivine-type phosphate compound and a content of the iron in the olivine-type phosphate compound is 100 parts by mole, the content of the manganese in the olivine-type phosphate compound is 50 parts by mole or more and 90 parts by mole or less,
the central part is a secondary particle formed by granulating a plurality of primary particles,
a first median diameter relating to the plurality of primary particles is 0.01 μm or more and 0.5 μm or less,
a second median diameter relating to the plurality of secondary particles is 1 μm or more and 20 μm or less,
the covering part contains a nitrile group, and
the positive electrode active material layer has a porosity of 20% or more and 40% or less.

2. The secondary battery according to claim 1, wherein
the first median diameter is 0.1 μm or more and 0.3 μm or less,
the second median diameter is 5 μm or more and 15 μm or less, and
the porosity is 25% or more and 35% or less.

3. The secondary battery according to claim 1, wherein
the positive electrode active material layer further contains a positive electrode binder, and
the positive electrode binder contains a nitrile group.

4. The secondary battery according to claim 3, wherein the positive electrode binder contains at least one of polyacrylonitrile and an acrylonitrile-ethylhexyl acrylate copolymer.

5. The secondary battery according to claim 1, wherein
the positive electrode further includes a positive electrode current collector that supports the positive electrode active material layer, and
when the positive electrode active material layer is bisected into a first positive electrode active material layer positioned on a side close to the positive electrode current collector and a second positive electrode active material layer positioned on a side far from the positive electrode in a thickness direction of the positive electrode active material layer,
a ratio of a total formation amount of a plurality of the covering parts in the second positive electrode active material layer to a total formation amount of a plurality of the covering parts in the first positive electrode active material layer is 0.6 or more and 1.4 or less.

6. The secondary battery according to claim 1,
the secondary battery being a lithium secondary battery.

7. A positive electrode for a secondary battery,
the positive electrode comprising a positive electrode active material layer,
wherein
the positive electrode active material layer contains a plurality of positive electrode active material particles,
each of the plurality of positive electrode active material particles includes:
a central part containing an olivine-type phosphate compound; and
a covering part provided on a surface of the central part,
the olivine-type phosphate compound contains manganese and iron as constituent elements,
when a sum of a content of the manganese in the olivine-type phosphate compound and a content of the iron in the olivine-type phosphate compound is 100 parts by mole, the content of the manganese in the olivine-type phosphate compound is 50 parts by mole or more and 90 parts by mole or less,
the central part is a secondary particle formed by granulating a plurality of primary particles,
a first median diameter relating to the plurality of primary particles is 0.01 μm or more and 0.5 μm or less,
a second median diameter relating to the plurality of secondary particles is 1 μm or more and 20 μm or less,
the covering part contains a nitrile group, and
the positive electrode active material layer has a porosity of 20% or more and 40% or less.
